(19) United States
(12) Patent Application Publication
(10) Pub. No.: US 2010/0304906 A1
(43) Pub. Date: Dec. 2, 2010

(54) TRANSMISSION CHAIN

(75) Inventors: Seigo Ohsawa, Osaka (JP); Arimasa Kaga, Osaka (JP)

Correspondence Address: HOWSON & HOWSON LLP, 501 OFFICE CENTER DRIVE, SUITE 210, FORT WASHINGTON, PA, 19034, US

(73) Assignee: Tsubakimoto Chain Co., Nakanoshima Mitsui Bldg., Osaka (JP)

(21) Appl. No.: 12/770,910

(22) Filed: Apr. 30, 2010

(30) Foreign Application Priority Data
May 26, 2009 (JP) 2009126093

(51) Int. Cl. F16H 57/05

(52) U.S. Cl. 474/91

(57) ABSTRACT

In a roller chain or rollerless bushing chain for transmission of power, hollow connecting pins are swaged to the plates of the outer links. Each pin has at least one oil conducting passage extending from its hollow interior to its exterior whereby lubricating oil can flow through the pin from the ends thereof and into the clearance between the pin and its surrounding bushing.

### CROSS REFERENCE TO RELATED APPLICATIONS

This application claims priority under Title 35, United States Code, §119 (a)-(d) on the basis of Japanese Patent Application No. 2009-126093, filed on May 26, 2009. The disclosure of Japanese Patent Application No. 2009-126093 is herein incorporated by reference in its entirety.

### FIELD OF THE INVENTION

This invention relates to a transmission chain for use in power transmission mechanisms such as the timing drive of an internal combustion engine or a transmission in an industrial machine. The invention relates more specifically to a transmission chain adapted for use in an oily environment.

### BACKGROUND OF THE INVENTION

Automobiles and many industrial machines include power transmissions in which a transmission chain is used to transmit rotation from a driving sprocket to one or more driven sprockets. For instance, the internal combustion engine of an automobile is typically provided with a timing drive for transmitting power from a crankshaft sprocket to one or more camshaft sprockets.

Known transmission chains include roller chains and rollerless bushing chains. Such chains are composed of alternating inner and outer links. The inner links are composed of laterally spaced link plates connected by two bushings. The outer links are composed of laterally spaced link plates connected by two pins. Each pin of each outer link extends through a bushing of an adjacent inner link. An example of such a transmission chain is the roller chain shown in FIG. 10. In the chain, inner links 540 and outer links 570 are arranged in alternating relationship along the longitudinal direction of the chain. In the inner link 540, both ends of a pair of front and rear bushings 530, one of which is shown in FIG. 10, are press-fit into bushing holes of a pair laterally spaced, parallel inner plates 510. In the outer link 570, both ends of a pair of front and rear connecting pins 560, one of which is shown in FIG. 10, are fastened to pin holes in laterally spaced, parallel plates 550. Each of the two pins of each outer link extends through a bushing in an adjacent inner link so that the inner and outer links are articulably connected in alternating relationship.

Such a chain is shown and described in Japanese laid-open Patent Application No. 2003-176853.

To fasten the connecting pins 560 to the pin holes of the outer plates 550, a swaging operation is applied to the ends of the connecting pin 560 that project from the outside surfaces of the outer plates 550, using a riveting die D as shown in FIG. 1.

It is also known to use a hollow cylindrical pin as a connecting pin in a transmission chain, as disclosed in Japanese laid-open Patent Application No. 2007-57377.

In the conventional roller chain described above, because both ends of the connecting pin 560 protrude beyond the outer side surfaces of the outer plates 550, as shown in FIGS. 10 and 11, a chain guide G having a deep chain-receiving groove as shown in FIG. 12, requires a step G′ to avoid interference with the connecting pins 560.

Another problem with the conventional roller chain is that. because the connecting pins protrude beyond the sides of the outer plates 550, air resistance generates noise.

Another problem with the conventional roller chain is that, as shown in FIG. 13, the gap between the outer surface of the connecting pin 560 and the inner surface of the bushing 530 becomes narrow at when a tensile force acts on the chain. The outer peripheral surface of the pin and the inner peripheral surface of the bushing prone can be damaged by wear and burning at a sliding region S due to inadequate lubrication.

### SUMMARY OF THE INVENTION

Accordingly, the invention aims at solving the problems described above by providing a transmission chain in which oil is steadily supplied from the outer sides of outer plates of the chain to the outer surfaces of the connecting pins, and in which a weight reduction of the chain, reduction in air resistance, and downsizing of the chain guides can be realized.

The transmission chain in according to the invention is an elongated, endless, chain, comprising inner and outer links connected in alternating relationship in the direction of elongation of the chain by connecting pins. Each inner link comprises a pair of parallel, opposed, inner plates spaced from each other in the direction of the width of the chain and a pair of bushings press-fit into bushing holes in the inner plates and being spaced from each other along the direction of elongation of the chain. Each outer link comprises a pair of parallel, opposed, outer plates spaced from each other in the direction of the width of the chain, said outer plates having outside surfaces facing in opposite direction. Pin holes extend through the outer plates, and have swaging bores formed by counter-boring the pin holes from the outside faces of the outer plates. A pair of connecting pins extending into the pin holes in the outer plates of each outer link. The connecting pins are spaced from each other along the direction of elongation of the chain and are secured to the swaging bores of the pin holes by swaged end portions of each pin, which are swaged from the outer sides of the outer plates. The link plates of each outer link overlap the inner link plates of two successive inner links in the chain and a connecting pin of each of said two successive inner links extends through one of the bushings of the last-mentioned outer link. Each of the connecting pins has a bore extending therethrough along the direction of the width of the chain from an opening at one end thereof to an opening at the other end thereof, and a transverse oil communicating hole leading from the bore to the outer peripheral surface of the connecting pin.

Lubricating oil supplied to the interior of the pin from an end thereof can flow through the transverse oil communicating hole to the outer peripheral surface of the pin so that an oil film can be reliably maintained on the outer surfaces of the pin. When the chain is operated in an oily environment, as in the timing chain enclosure of an engine, adequate lubrication of the chain can be maintained without the need for a special oil supply device or oil supply reservoir. Thus, it is possible to facilitate smooth relative sliding between the connecting pins and the surrounding bushings and to prevent the outer surfaces of the connecting pins and the inner surfaces of the bushings from being damaged as a result of burning or wear.

When assembly of the chain is completed, the ends of the connecting pins do not protrude beyond the outer sides of the outer plates. Consequently, lubricant can flow readily from the outsides of the outer plates into the connecting pins, and through the transverse holes in the pins to the outer surfaces of the pins. Thus it becomes possible to reduce wear of the chain and elongation resulting from wear.

In addition, the absence of protruding parts of the connecting pins results in an overall weight reduction, which gives rise to a number of benefits including reduction of noise, vibration and harshness (NVH). Absence of protruding parts also reduces air resistance and thereby reduces noise resulting from air turbulence in the operation of the chain.

Finally, the shortening of the connecting pins makes it possible to reduce the widths of the tensioner levers and other chain guides used to restrict the path of travel of the chain.

In a preferred embodiment, the swaged end portions of each of the connecting pins have tapered inner peripheral surfaces. The cross-sectional areas of the bores of the connecting pins surrounded and defined by the tapered inner peripheral surfaces progressively decrease, proceeding from each end of the connecting pin toward the opposite end thereof. The wide openings of the tapered inner peripheral surfaces at the ends of the connecting pins improve the collection of lubricating oil so more oil can be supplied to interface between the outer peripheral surfaces of the pins and the inner peripheral surfaces of the bushings.

According to another aspect of the invention, the swaging bores in outer link plates of the outer links have tapered inner peripheral surfaces whereby the cross-sectional area of each swaging bore progressively decreases proceeding inwardly from the outside face of the outer link plate in which the swaging bore is formed. The tapering of the swaging bore prevents the connecting pins from being pulled out of the swaging bores so that strong and secure connection of the pins to the outer plates is maintained.

Because it is possible to widen both ends of a pin equally by swaging both ends of the pin within the swaging bores, it is possible to prevent loss of strength at the ends of the pins.

In another embodiment of the invention, the connecting pins have grooves formed in the walls of their bores. These grooves extend from the outer ends of the bores to the inner ends of the swaged end portions, and guide the flow of oil from the outer sides of the outer plates to the insides of the connecting pins, to promote a reliable supply of oil through the insides of the connecting pins to their outer peripheral surfaces.

In still another aspect of the invention, an oil conducting groove is formed in the outer peripheral surface of each connecting pin, and extends from the transverse oil communicating hole of the pin toward the ends thereof. The oil conducting groove improves the flow of oil along the length of the outer peripheral surface of the pin. Preferably, the oil conducting groove is formed in the outer peripheral surface of each pin of each outer link on the side thereof facing the other connecting pin of the same outer link so that oil is supplied reliably to the part of the interface between the pin and its surrounding bushing at which contact pressure resulting from chain tension is the greatest.

### BRIEF DESCRIPTION OF DRAWINGS

FIG. 1 is a drawing showing a mode of use of a transmission chain of a first embodiment of the invention;

FIG. 2 is a partly cut-away overall schematic view of a part of the transmission chain shown in FIG. 1;

FIG. 3 is an enlarged section view of the part of the transmission chain shown in FIG. 1;

FIG. 4 is a perspective view of a cylindrical connecting pin seen in section centering on an end portion thereof;

FIG. 5 is an explanatory view showing a method for swaging the cylindrical connecting pin to an outer plate;

FIG. 6 is a perspective view showing the cylindrical connecting pin used for the transmission chain shown in FIG. 1;

FIG. 7 is a section view showing a sliding state of the cylindrical connecting pin and a bushing;

FIG. 8 is an explanatory view showing a sliding-contact state of the transmission chain and a chain guide;

FIG. 9 is an explanatory view showing a method for swaging a cylindrical connecting pin composing the transmission chain according to a second embodiment of the invention;

FIG. 10 is a section view showing a prior art roller chain;

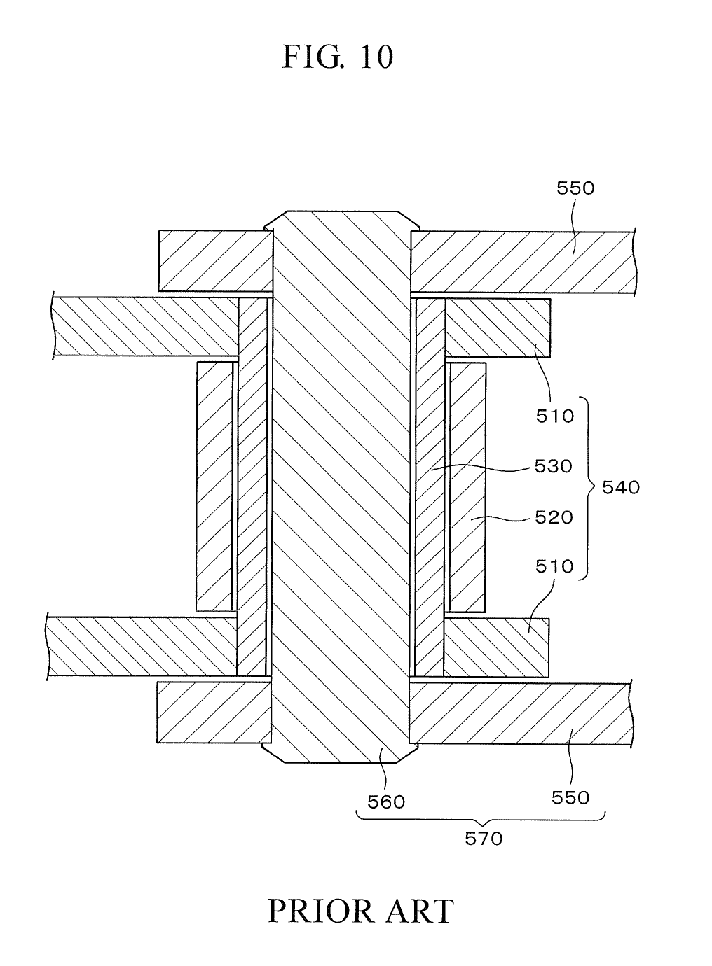

FIG. 11 is an explanatory view showing a method for caulking a prior art cylindrical connecting pin to a roller chain;

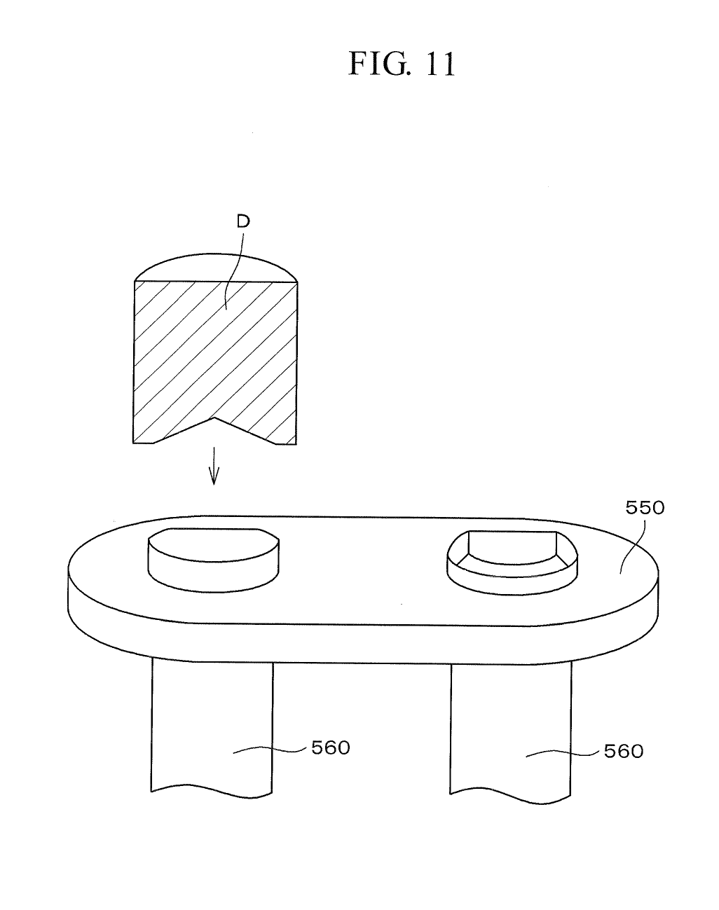

FIG. 12 is an explanatory view showing a sliding-contact state of the prior art roller chain and a chain guide; and

FIG. 13 is a section view showing a sliding state of a connecting pin and a bushing of the prior art roller chain.

### DETAILED DESCRIPTION OF THE PREFERRED EMBODIMENTS

The invention can be embodied in any of a large number of variations, provided that the transmission chain has inner links with bushings, and outer links with hollow pins having swaged ends fitting in counter-bored pin holes formed in the outside faces of the outer link plates, and provided that each of the connecting pins has a bore extending therethrough along the direction of the width of the chain from an opening at one end thereof to an opening at the other end thereof, and a transverse oil communicating hole leading from the bore to the outer peripheral surface of the connecting pin.

For instance, the transmission chain of the invention can be either a roller chain or a rollerless bushing chain. The oil communicating hole may have any configuration as long as it can deliver oil from the inside of the pin to the outer peripheral surface thereof. Thus, the hole may be a circular hole and positioned at a central location along the length of the pin. Alternatively, plural holes, for example three holes, can be distributed along the length of the pin. The holes can have various shapes other than circular. For example, the holes can have a semi-circular or triangular shape.

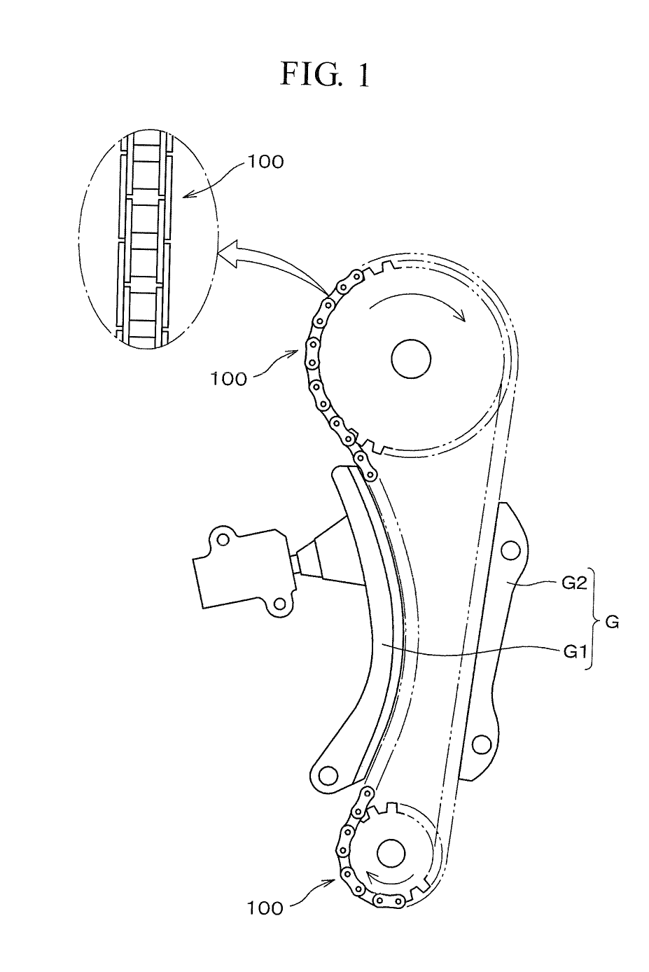

As shown in FIG. 1, the transmission chain 100 is a timing chain used in an automobile engine to deliver power from a crankshaft sprocket to a camshaft sprocket. The chain is guided in sliding relationship by guides G, which include a pivoted tensioner lever G1 and a fixed guide G2.

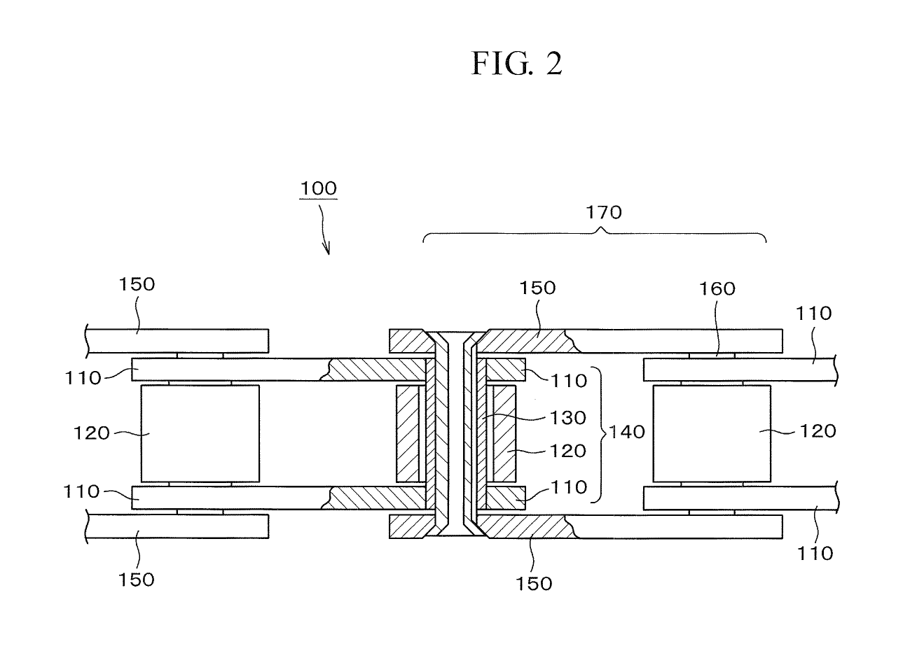

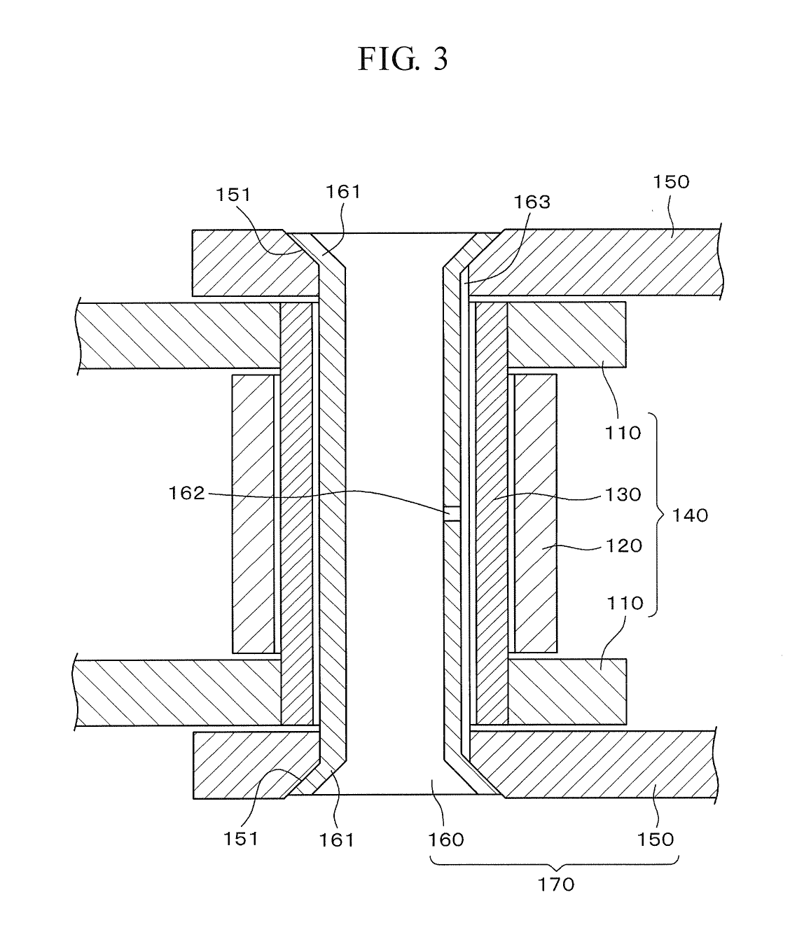

As shown in FIGS. 2 and 3, the chain is composed of inner links 140 and outer links 170 in alternating, overlapping relationship. In each inner link 140, both ends of each of a pair of front and rear bushings 130, which are surrounded by rollers 120, are press-fit into bushing holes in parallel right and left inner plates 110 disposed in spaced relationship each other. In each outer link 170, both ends of a pair of front and rear connecting pins 160 are inserted into pin holes of a pair of parallel right and left outer plates 150 disposed in parallel relationship to each other. The connecting pins are preferably generally in the form of circular cylinders, except at their ends, and at the locations of their transverse oil passages and any oil carrying grooves formed on their outer peripheral surfaces.

The inner links 140 and the outer links 170 are connected by virtue of the fact that each of the connecting pins 160 of an outer link extends loosely through a bushing 130 of an adjacent inner link.

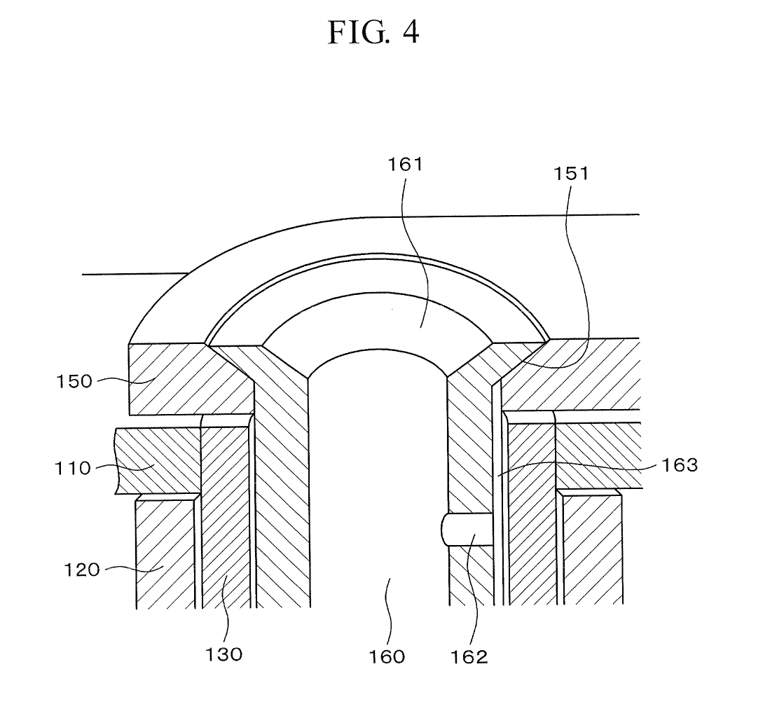

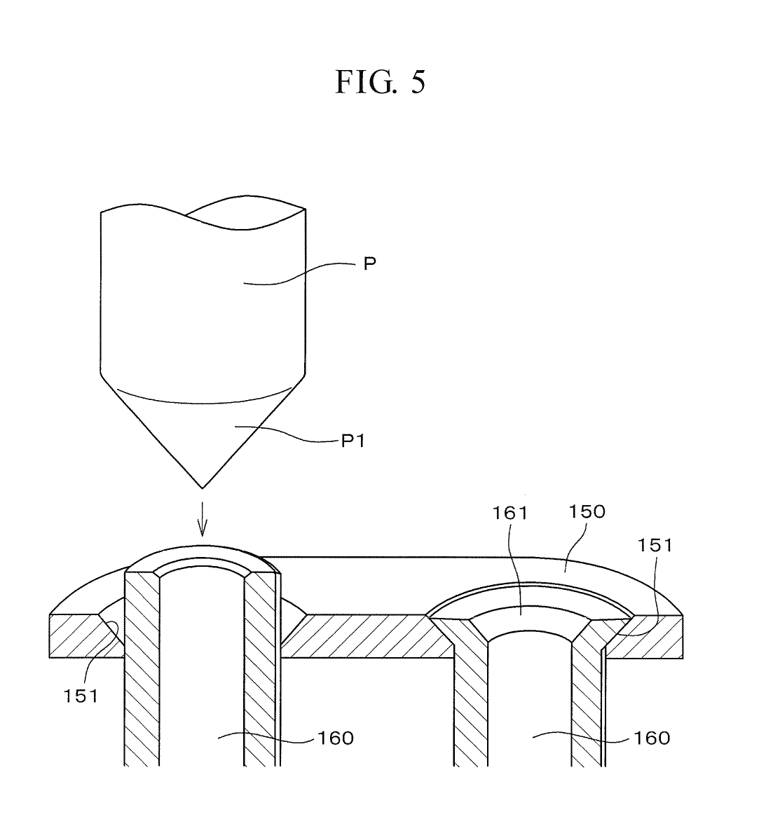

As shown in FIGS. 3 and 4, each outer plate 150 has a swaging bore 151 formed by counter-boring the pin hole from the outer side of the plate. The connecting pin 160 has riveting portions 161 at both ends that are swaged within the swaging bores 151 of the outer plates. The riveting portions 161 are inserted into the pin holes of the outer plates 150 so that a end part of the pin protrudes from the outer side of the outer plate 150 as shown in FIG. 5. Each of the protruding parts is swaged into a swaging bore 151 by a riveting punch P having a conical head P1.

The riveting portion 161 of the connecting pin 160 has tapered inner and outer peripheral surfaces whose cross-section decreases proceeding from the end of the pin toward the opposite end, i.e., from the outer side toward the inner side of the outer plate 150, as shown in FIGS. 2-5. The swaging bore 151 of the outer plate 150 also has a tapered inner peripheral surface, the cross-section of which decreases proceeding from the outer side to the inner side of the plate.

As shown in FIGS. 3, 4 and 6, the connecting pin 160 has an oil communicating hole 162, extending through the peripheral wall of the connecting pin 160. Oil flows from the ends of the pin into the hollow interior thereof. The oil communicating hole 162 delivers oil from the interior of the pin to its outer peripheral surface.

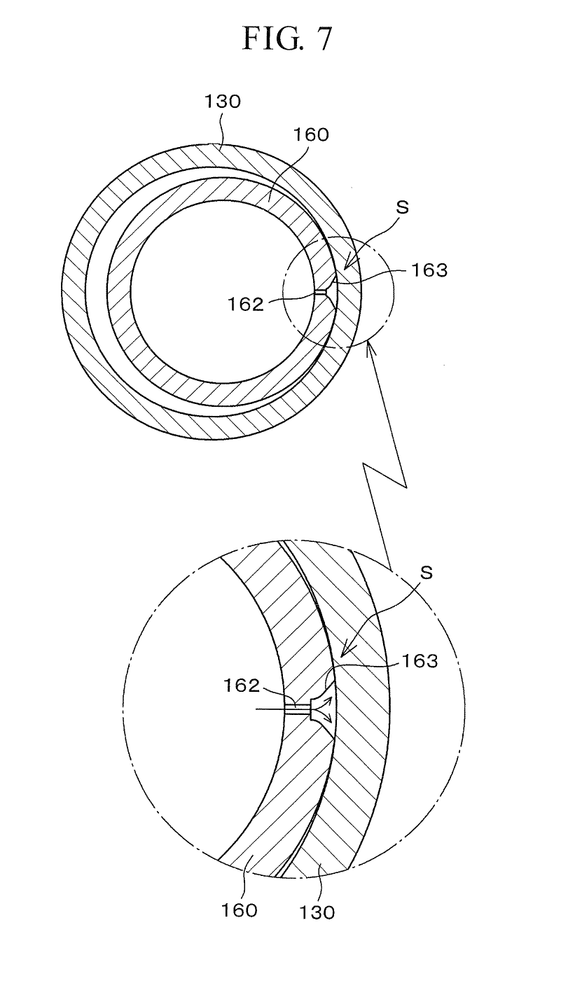

The outside of the connecting pin 160 is also provided with a concave oil conducting groove 163 (FIGS. 3, 4 and 6) for guiding the oil that flows outward through the hole 162 along the longitudinal direction of the pin. The oil conducting groove is formed in the outer peripheral surface of each connecting pin, and extends from the transverse oil communicating hole of the pin toward the ends thereof. The oil conducting groove improves the flow of oil along the length of the outer peripheral surface of the pin. Preferably, the oil conducting groove is formed in the outer peripheral surface of each pin of each outer link on the side thereof facing the other connecting pin of the same outer link so that oil is supplied directly to the region S of the interface between the pin and its surrounding bushing. As shown in FIG. 7, it is within this region S that the gap between the pin and the bushing is the smallest, the contact pressure resulting from chain tension is the greatest, and the thickness of the lubricating oil film is the least,

As shown in FIGS. 2-4 and 6, the oil communicating hole 162 is preferably located at a location midway between the plates of the outer link. That is, the oil communicating hole 162 is formed at a central location along the length of the connecting pin 160. As a result, hole 162 is remote from the parts of the bushing 130 that are most deformed in the process of press-fitting the bushing 130 into the bushing holes of the inner plates 110.

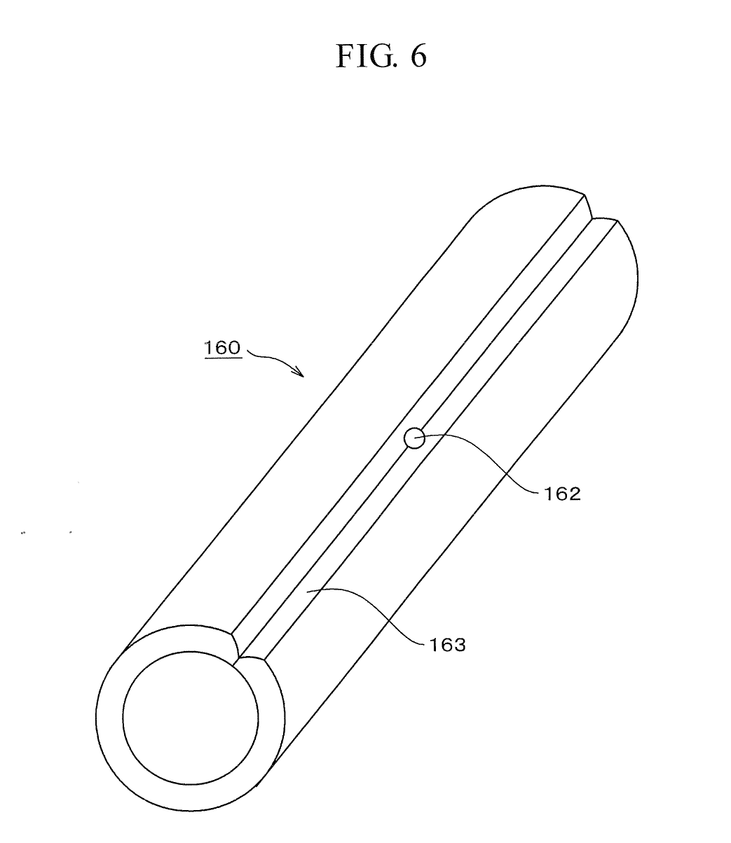

The connecting pin 160 can be formed by bending a plate having beveled ends and semi-circular cut-away portions centrally located along the lengths of the beveled ends. As shown in FIG. 6, the oil conducting groove 163 is formed by connecting the beveled ends of the plate, and the oil communicating hole 162 is formed by the cut-away portions, which meet each other.

The oil communicating hole 162 may have any configuration as long as it allows oil to flow from the interior to the outer peripheral surface of the connecting pin. As mentioned previously, the oil communicating hole can have any of many shapes, and a plurality of oil communicating holes can be provided in each connecting pin.

The oil guiding groove 163, which guides oil from the oil communicating hole along the length of the connecting pin, can have various alternative configurations. For example, the oil guiding groove can have a wave-like shape, or can be bent at its center along the longitudinal direction of the connecting pin.

The connecting pin 160 has its riveting portions 161 at both ends of the pin swaged into the swaging bores 151 of the outer plates 150 which are formed by counter-boring the pin holes of the outer plates 150 from the outer sides thereof.

Because the ends of the connecting pin 160 are swaged into swaging bores formed in the outer sides of the outer plates, the ends of the connecting pin do not protrude beyond outer sides of the outer plates 150 after completion of assembly of the chain. The ends of the connecting pin 160 can be located slightly to the inside of the outer side surfaces of the outer plates 150 as seen in FIGS. 2-5. When the ends of the connecting pins are slightly recessed in this manner, oil readily flows into the connecting pin 160 along the outer side surfaces of the outer plates and the inner peripheral surfaces of the swaging bores 151 of the outer plates 150. Consequently, more oil can be supplied to the interface between the outer peripheral surfaces of the connecting pins and the inner peripheral surfaces of the bushings 130 through the oil communicating holes 162 for improved prevention of wear and elongation of the chain.

Because the connecting pins are hollow, and because their ends 160 are prevented from projecting outward beyond of the outer sides of the plates 150, the connecting pins are lighter in weight than conventional connecting pins. It is thus possible to reduce the overall weight of the chain significantly, and to suppress noise for improved “NVH” performance.

In addition, because air resistance is reduced by the elimination of the protruding portions of the connecting pins, it is also possible to suppress noises resulting from air turbulence which are produced when ends of the connecting pins protrude beyond the outer plates of a chain.

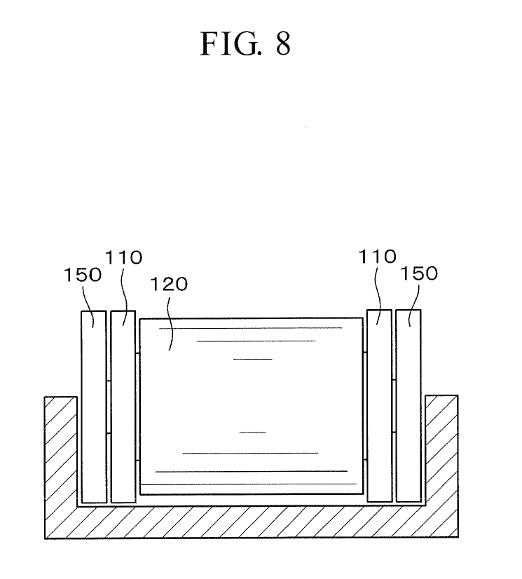

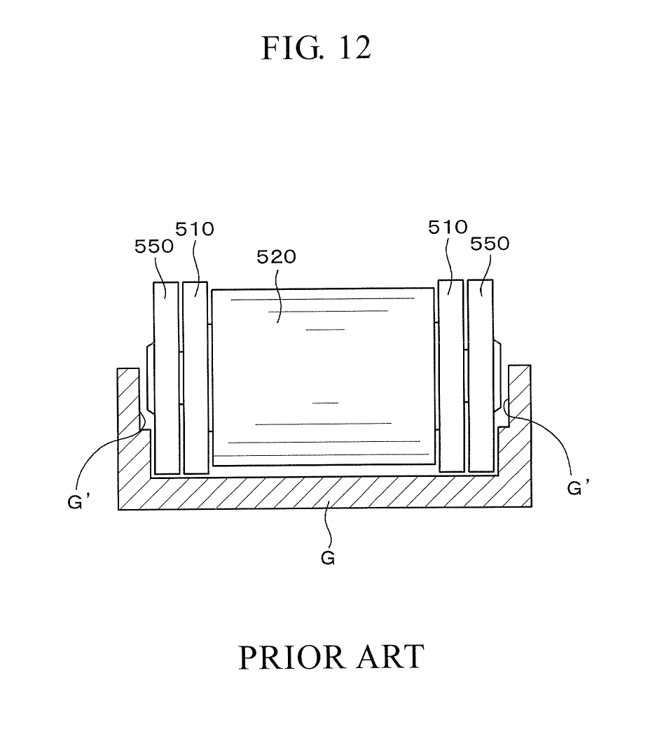

The shortening of the connecting pins 160 also makes it possible to simplify, and reduce the widths of, the tensioner lever G1 and the chain guide G2 (FIG. 1) and other chain guides used to restrict the path of travel of the chain. Thus, relationship between the chain and the guide structure can be as shown in FIG. 8, where the guide does not need to have steps to accommodate the protruding ends of the connecting pins as in FIG. 12.

Lubricating oil supplied to the interior of the pin from an end thereof can flow through the transverse oil communicating hole 162 to the outer peripheral surface of the connecting pin 160 so that an oil film can be reliably maintained on the outer surfaces of the pin. Consequently, adequate lubrication of the chain can be maintained without the need for a special oil supply device or oil supply reservoir. Thus, it is possible to facilitate smooth relative sliding between the connecting pins and the surrounding bushings and to prevent the outer surfaces of the connecting pins and the inner surfaces of the bushings from being damaged as a result of burning or wear.

As shown in FIGS. 3, 4, and 5, portion 161 of the connecting pin 160 has at a tapered inner peripheral surface the diameter of which progressively decreases from the outer end of the pin toward the opposite end of the pin. Accordingly, wide openings are provided at both ends of the connecting pin 160 that collect oil and guide the oil smoothly toward the inside of the connecting pin 160, so that an adequate supply of oil is provided to the interface between the outer surface of the pin 160 and the inner surface of the bushing 130.

The swaging bore 151 of the outer plate 150 also has a tapered inner peripheral surface the diameter of which progressively decreases proceeding from the outside surface of the plate toward the inside surface. The tapered inner surface of the swaging bore 151 prevents the end portion 161 of the pin from being pulled out of the swaging bore 151, so that the connecting pin 160 is strongly secured to the outer plate 150.

Because both ends of the pin can be widened equally in swaging both ends of the pin within the swaging bores 151, it is possible to avoid the prevent loss of strength at the ends of the pin.

The oil-guiding groove 163, which connects with the oil communicating hole 162 is a concave groove formed on the outer peripheral surface of the connecting pin and extending along the longitudinal direction of the pin. Oil flowing outward through from the oil communicating hole 162 is guided by groove 163 to along the longitudinal direction of the pin, so that an oil film can be formed on the outer peripheral surface over the entire length of the cylindrical part of the pin.

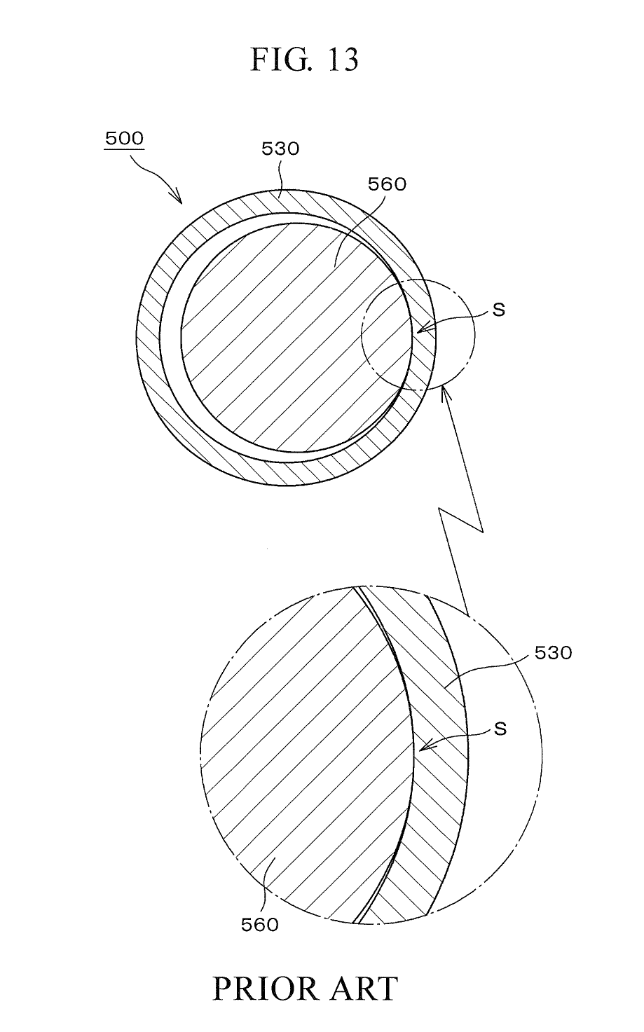

The oil guiding groove 163 is preferably provided in the sliding region S between the bushing 130 and the connecting pin 160, which is the area where pressure is applied between the pin and the bushing when the chain is in tension. The region S is the side of the connecting pin that faces the other connecting pin of the same link. Oil is therefore supplied directly to the sliding region S between the bushing 130 and the connecting pin 160 where the gap is narrowest as shown in FIG. 13, and where the oil film would tend to be inadequate in a conventional chain. Positioning the oil guiding groove 163 in sliding region S ensures a steady supply of oil to the sliding region, to prevent the bushing 130 and the connecting pin 160 from being damaged by burning or wear.

Although the oil guiding groove can be a straight groove, it may also have a different configuration as long as it guides oil from the oil communicating hole in the longitudinal direction on the outer peripheral surface of the pin. Thus, the groove can have a curved shape, deviating from the straight configuration shown in FIG. 6, and can even include reverse bends so that it has a wave-like shape.

The oil communicating hole 162 is also preferably located at a position along the length of the connecting pin between the outer link plates 150 and remote from both link plates. Positioning the hole 126 at a location remote from the outer link plates prevents the hole from sliding against a part of the bushing that is slightly deformed in the process of press-fitting the bushing 130 into a bushing hole of an inner plate 110. Thus, excessive localized surface pressure between the outer peripheral surface of the pin and the inner peripheral surface of the bushing can be avoided.

The oil communicating hole 162 and the oil guiding groove 163 are preferably formed where the edges of a plate are brought together when the pin is formed by bending the plate into a cylinder. Oil circulated flows to the outside of the pin not only through the oil communicating hole 162, but also by capillary action through very small passages inevitably formed where the edges of the plate join each other. Oil thus flows into the oil guiding groove 163 not only through hole 162 but also through gaps in the pin at other locations along the length of the groove, further ensuring that an adequate oil film is maintained.

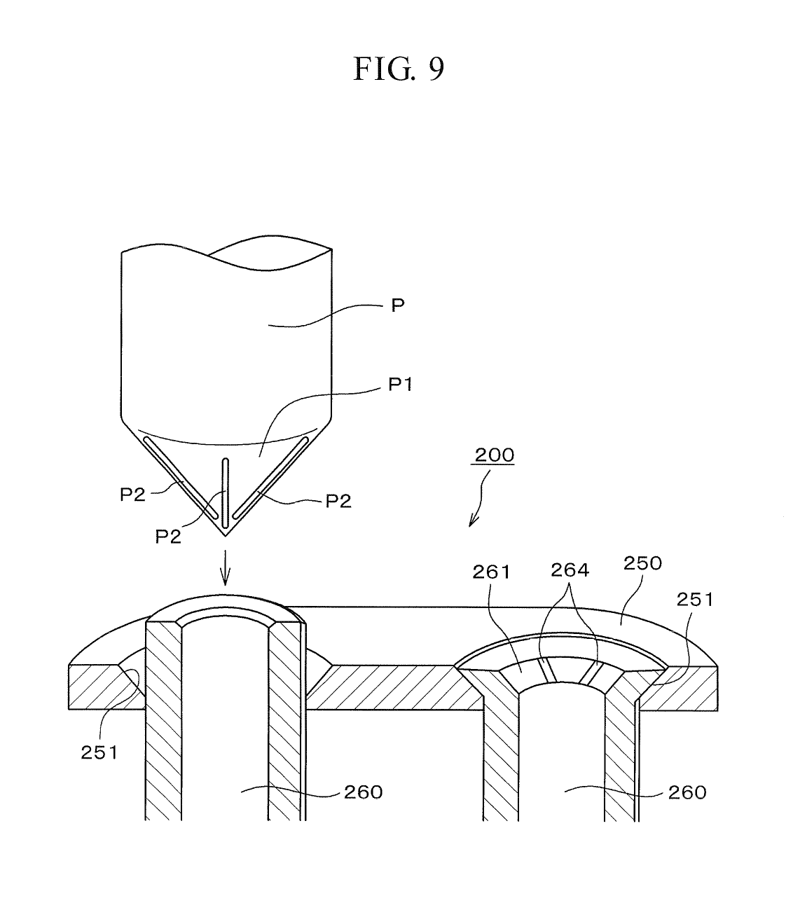

FIG. 9 illustrates another embodiment, in which a transmission chain 200 is similar to the above-described embodiment except that the connecting pin 260 is provided with oil guiding grooves in the tapered inner peripheral surfaces of its end portions. Parts identical to those of the first embodiment are designated by reference numbers exceeding by 100 the reference numbers of corresponding parts in the first embodiment.

The end portion 261 of the connecting pin 260 has oil grooves 264 on its inner peripheral surface for guiding oil from the outer side of the outer plate 250 to the inside of the pin. The grooves 264 are formed by swaging the connecting pin 260 which protrudes outward from the swaging bore 251 beyond the outer side the outer plate 250. Swaging is carried out by a punch P having groove-forming ribs P2 on the outer peripheral surface of a conical head P1.

The oil guiding grooves 264 guide oil outer side surfaces of the outer plates 250 to the inside of the connecting pin 260, ensuring a stable supply of oil through the inside of the pin, and through the transverse oil communicating hole or holes, to the interface between the of the pin and the surrounding bushing.

What is claimed is:

1. An elongated endless transmission chain, comprising:
inner and outer links connected in alternating relationship in the direction of elongation of the chain;
wherein each inner link comprises a pair of parallel, opposed, inner plates spaced from each other in the direction of the width of the chain and a pair of bushings press-fit into bushing holes in the inner plates, said bushings being spaced from each other along the direction of elongation of the chain;
wherein each outer link comprises a pair of parallel, opposed, outer plates spaced from each other in the direction of the width of the chain, said outer plates having outside surfaces facing in opposite directions and pin holes extending through said outer plates, the pin holes having swaging bores formed by counter-boring the pin holes from the outside faces of the outer plates, and a pair of connecting pins extending into said pin holes in the outer plates, said connecting pins being spaced from each other along the direction of elongation of the chain and being secured to the swaging bores of said pin holes by swaged end portions of each pin, the swaged end portions being swaged from the outer sides of the outer plates;
wherein the link plates of each outer link overlap the inner link plates of two successive inner links in the chain and a connecting pin of each of said two successive inner links extends through one of the bushings of the last-mentioned outer link; and
wherein each of said connecting pins has a bore extending therethrough along the direction of the width of the chain from an opening at one end thereof to an opening at the other end thereof, and a transverse oil communicating hole leading from said bore to the outer peripheral surface of the connecting pin, whereby lubricating oil supplied to the interior of the pin from an end thereof can flow through the transverse oil communicating hole to the outer peripheral surface of the connecting pin.

2. The transmission chain according to claim 1, wherein the swaged end portions of each of said connecting pins have tapered inner peripheral surfaces whereby the cross-sectional areas of bores of said connecting pins surrounded and defined by said tapered inner peripheral surfaces progressively decrease proceeding from each end of the connecting pin toward the opposite end thereof.

3. The transmission chain according to claim 1, wherein each swaging bore has a tapered inner peripheral surface whereby the cross-sectional area of each swaging bore progressively decreases proceeding inwardly from the outside face of the outer link plate in which the swaging bore is formed.

4. The transmission chain according to claim 2, wherein each swaging bore has a tapered inner peripheral surface whereby the cross-sectional area of each swaging bore progressively decreases proceeding inwardly from the outside face of the outer link plate in which the swaging bore is formed.

5. The transmission chain according to claim 1, wherein the connecting pins have lubricant-guiding grooves formed in the walls of their bores, said grooves extending from the outer ends of the bores to the inner ends of the swaged end portions.

6. The transmission chain according to claim 2, wherein the connecting pins have lubricant-guiding grooves formed in the walls of their bores, said grooves extending from the outer ends of the bores to the inner ends of the swaged end portions.

7. The transmission chain according to claim 3, wherein the connecting pins have lubricant-guiding grooves formed in the walls of their bores, said grooves extending from the outer ends of the bores to the inner ends of the swaged end portions.

8. The transmission chain according to claim 4, wherein the connecting pins have lubricant-guiding grooves formed in the walls of their bores, said grooves extending from the outer ends of the bores to the inner ends of the swaged end portions.

9. The transmission chain according to claim 1, wherein each pin has an outer peripheral surface and an oil conducting groove formed in said outer peripheral surface and extending from the transverse oil communicating hole of the pin toward the ends thereof.

10. The transmission chain according to claim 9, wherein the oil conducting groove is formed in the outer peripheral surface of each pin of each outer link on the side thereof facing the other connecting pin of the same outer link.
